(19) United States
(12) Patent Application Publication
(10) Pub. No.: US 2018/0129300 A1
(43) Pub. Date: May 10, 2018

(54) INPUT-BASED CANDIDATE WORD DISPLAY METHOD AND APPARATUS

(71) Applicant: BEIJING QIHOO TECHNOLOGY COMPANY LIMITED, Beijing (CN)

(72) Inventor: Haichao GUO, Beijing (CN)

(21) Appl. No.: 15/563,941

(22) PCT Filed: Mar. 31, 2016
(86) PCT No.: PCT/CN2016/078050

§ 371 Date: Oct. 2, 2017

(30) Foreign Application Priority Data
Apr. 1, 2015 (CN) 201510152338.3

(51) Int. Cl. G06F 3/023; G06F 17/27; G06F 3/01; G06F 17/30

(52) U.S. Cl. CPC G06F 3/0237; G06F 17/3064; G06F 3/018; G06F 17/2795

(57) ABSTRACT

The present invention discloses an input-based candidate word display method and apparatus. The method comprises: adopting an input pinyin character string to search for one or more candidate words; determining whether the candidate words are allographic synonyms; if so, configuring allographic synonym prompt information for the candidate words belonging to the allographic synonyms; and displaying the one or more candidate words and the allographic synonym prompt information. In the embodiments of the present invention, a user is prompted that the candidate words are allographic synonyms, thereby reducing a probability of incorrect input and improving input efficiency.

### CROSS-REFERENCE TO RELATED APPLICATIONS

This application is the national stage of International Application No. PCT/CN2016/078050 filed Mar. 31, 2016, which claims the benefit of Chinese Patent Applications No. CN201510152338.3, filed Apr. 1, 2015, the entirety is incorporated herein by reference.

### FIELD OF TECHNOLOGY

The present invention relates to the field of input method technologies, and more particularly, to an input-based candidate word display method and an input-based candidate word display apparatus.

### BACKGROUND

With the high-speed development of information era, users frequently need to input information on various occasions. For example, a keyword is inputted into a search engine to search for a webpage, a text is inputted into an instant messaging tool to communicate with other users, and so on.

In the process of using the Chinese, allographic synonyms appear due to factors such as interchangeability of words or characters and synonymous substitution, etc.

When a user inputs a certain character string, an input method often simultaneously provides a plurality of allographic synonyms having the same translation or similar explanation.

For example, when the user inputs a pinyin character string “san′ yang′ kai′ tai”, “ [symbol] ” and “ [symbol] ” may be provided simultaneously.

In general, literature professional skills of the user is not strong enough so that the user is unable to clearly know which is correct, and thus the user may be likely misled to input.

If the user wants to inquire which word is correct, the user needs to start a browser to search, which is complex and time-consuming in operation, and low in input efficiency.

### SUMMARY

In view of the above problems, the present invention is proposed to provide an input-based candidate word display method and a corresponding input-based candidate word display apparatus to overcome or at least partially solve or mitigate the above problems.

According to an aspect of the present invention, there is provided an input-based candidate word display method, comprising following steps:

adopting an input pinyin character string to search for one or more candidate words;

determining whether the candidate words are allographic synonyms; if so, configuring allographic synonym prompt information for the candidate words belonging to the allographic synonyms; and

displaying the one or more candidate words and the allographic synonym prompt information.

Alternatively, the allographic synonym prompt information comprises allographic synonym parsing information.

The step of displaying the one or more candidate words and the allographic synonym prompt information comprises:

displaying the allographic synonym parsing information when detecting a designated operation for the candidate words belonging to the allographic synonyms.

Alternatively, the step of configuring allographic synonym prompt information for the candidate words belonging to the allographic synonyms comprises:

configuring a trigger point for the candidate words belonging to the allographic synonyms, wherein the trigger point is associated with the allographic synonym parsing information.

Alternatively, the step of displaying the allographic synonym parsing information when detecting a designated operation for the candidate words belonging to the allographic synonyms comprises:

generating a popup layer when the trigger point is triggered by the designated operation; and

displaying the allographic synonym parsing information in the popup layer.

Alternatively, the allographic synonym prompt information comprises an allographic synonym identifier.

The step of configuring allographic synonym prompt information for the candidate words belonging to the allographic synonyms comprises:

configuring the allographic synonym identifier for the candidate words belonging to the allographic synonyms.

Alternatively, the step of displaying the one or more candidate words and the allographic synonym prompt information comprises:

displaying the allographic synonym identifier in an adjacent position of the candidate words belonging to the allographic synonyms.

Alternatively, the trigger point is configured in the allographic synonym identifier, and the designated operation comprises a hover operation.

Alternatively, the step of displaying the one or more candidate words comprises:

displaying, in a same interface, at least two candidate words which are allographic synonyms one another.

Alternatively, the allographic synonym parsing information comprises:

words which are allographic synonyms with the candidate words one another, and/or a link of a parsing page, wherein the parsing page is a page for parsing the words which are allographic synonyms with the candidate words one another.

Alternatively, the step of displaying the one or more candidate words and the allographic synonym prompt information comprises:

invoking a browser to load the parsing page through the link when the link is triggered.

Alternatively, the step of determining whether the candidate words are allographic synonyms comprises:

adopting the input pinyin character string to search for the allographic synonyms from a preset allographic synonym library.

According to another aspect of the present invention, there is provided an input-based candidate word display apparatus, comprising:

a searching module, configured to adopt an input pinyin character string to search for one or more candidate words;

a determining module, configured to determine whether the candidate words are allographic synonyms; if so, a configuring module is invoked;

the configuring module, configured to configure allographic synonym prompt information for the candidate words belonging to the allographic synonyms; and

a display module, configured to display the one or more candidate words and the allographic synonym prompt information.

Alternatively, the allographic synonym prompt information comprises allographic synonym parsing information.

The display module is further configured to:

display the allographic synonym parsing information when detecting a designated operation for the candidate words belonging to the allographic synonyms.

Alternatively, the configuring module is further configured to:

configure a trigger point for the candidate words belonging to the allographic synonyms, wherein the trigger point is associated with the allographic synonym parsing information.

Alternatively, the display module is further configured to:

generate a popup layer when the trigger point is triggered by the designated operation; and

display the allographic synonym parsing information in the popup layer.

Alternatively, the allographic synonym prompt information comprises an allographic synonym identifier.

The configuring module is further configured to:

configure the allographic synonym identifier for the candidate words belonging to the allographic synonyms.

Alternatively, the display module is further configured to:

display the allographic synonym identifier in an adjacent position of the candidate words belonging to the allographic synonyms.

Alternatively, the trigger point is configured in the allographic synonym identifier, and the designated operation comprises a hover operation.

Alternatively, the display module is further configured to:

display, in a same interface, at least two candidate words which are allographic synonyms one another.

Alternatively, the allographic synonym parsing information comprises:

words which are allographic synonyms with the candidate words one another, and/or a link of a parsing page, wherein the parsing page is a page for parsing the words which are allographic synonyms with the candidate words one another.

Alternatively, the display module is further configured to:

invoke a browser to load the parsing page through the link when the link is triggered.

Alternatively, the determining module is further configured to:

adopt the input pinyin character string to search for the allographic synonyms from a preset allographic synonym library.

According to still another aspect of the present invention, there is provided a computer program, which comprises a computer-readable code. When the computer-readable code runs on an input device, the input device is caused to execute the above input-based candidate word display method.

According to still another aspect of the present invention, there is provided a computer-readable medium, in which the above computer program is stored.

The present invention has following beneficial effects.

In the embodiments of the present invention, when candidate words searched out using a pinyin character string are allographic synonyms, allographic synonym prompt information is configured for the candidate words, and the candidate words and the allographic synonym prompt information are displayed to prompt a user that the candidate words are the allographic synonyms, thereby reducing a probability of incorrect input and improving input efficiency.

In the embodiments of the present invention, by displaying allographic synonym parsing information, frequency of operation of starting a browser for search is reduced for the user, operation convenience is improved, time consumption is reduced, and input efficiency is further enhanced.

Described above is merely an overview of the technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely comprised for the purpose of illustrating the preferred embodiments and should not be considered as limiting of the present invention. Further, throughout the drawings, same elements are indicated by same reference numbers. In the drawings:

FIG. 1 schematically illustrates a step flowchart of an input-based candidate word display method according to an embodiment of the present invention;

FIG. 2 schematically illustrates an example diagram of displaying allographic synonyms according to an embodiment of the present invention;

FIG. 3 schematically illustrates a structural block diagram of an input-based candidate word display apparatus according to an embodiment of the present invention;

FIG. 4 schematically illustrates a block diagram of an input device for performing the method according to the present invention; and

FIG. 5 schematically shows a storage unit for maintaining or carrying a program code for implementing the method according to the present invention.

### DESCRIPTION OF THE EMBODIMENTS

A further description of the present invention is made with reference to the accompanying drawings and specific embodiments hereinafter.

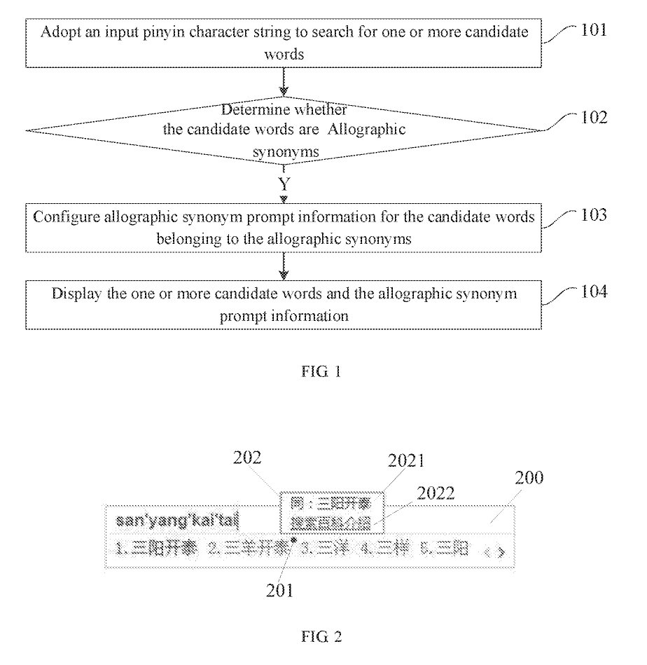

Referring to FIG. 1, a step flowchart of an input-based candidate word display method according to an embodiment of the present invention is illustrated. Specifically the method may comprise following steps:

Step 101: adopting an input pinyin character string to search for one or more candidate words.

It is to be noted that the embodiments of the present invention may be applied to an electronic device having an input function. The electronic device may comprise an mobile device such as a mobile phone, a tablet computer, a wearable device (for example, a bracelet, a watch or glasses), and may also comprise a fixed device such as a personal computer and so on, to which no limitation is imposed in the embodiments of the present invention.

These electronic devices generally may support operating systems comprising Windows, Android, IOS, WindowsPhone and the like, and may support to run an application program inputting by way of a keyboard (such as a virtual keyboard or a physical keyboard) and so on.

The keyboard may comprise a Sudoku keyboard, a full keyboard (such as a QWERT keyboard) and the like. The application program may comprise an input method program and so on.

Generally, the keyboard is provided with a plurality of keys, which are frequently used. Each of the keys may reflect one or more characters, which specifically may comprise a numeric character, an English character, a Chinese character (comprising a pinyin character, a stroke character and a five-stroke character), a symbol character and so on, so as to input a number, an English, a Chinese, a symbol and the like.

For example, in the Sudoku keyboard, the numeric character “2” is generally mapped, with the English characters “A”, “B”, “C”, “a”, “b” and “c”, the pinyin characters “a” (a vowel), “b” (an initial), “c” (an initial), and the stroke character “|”, to the same key.

After the user presses one or more keys down on the keyboard, the characters mapped by the keys may constitute a character string, wherein the character string composed of the pinyin characters may be referred to as a pinyin character string.

For the pinyin character string, the candidate words having the pronunciation (the pinyin character string) may be searched for from a default word library of the system using the input method (an app).

For example, when the pinyin character string inputted by the user is “san′ yang′ kai′ tai”, candidate words such as “ [symbol] ”, “ [symbol] ”, “ [symbol] ”, “ [symbol] ”, “ [symbol] ” and the like may be found in the default word library of the system by using input method (an app).

Step 102: determining whether the candidate words are allographic synonyms; if so, executing Step 103.

The allographic synonyms may refer to words having the same pronunciation, the same or similar meaning and a similar spelling (for example, different characters of a phrase or different sides of characters).

For example, “ [symbol] ” and “ [symbol] ”, “ [symbol] ” and “ [symbol] ”, “ [symbol] [symbol] ” and “ [symbol] ”, “ [symbol] ” and “ [symbol] ”, etc.

In an alternative embodiment of the present invention, Step 102 may comprise the following substeps.

Substep S11: adopting the input pinyin character string to search for the allographic synonyms from a preset allographic synonym library.

By applying the embodiments of the present invention, the allographic synonyms in the default word library of the system may be screened in advance and stored in an allographic synonym library (also referred to as a fault-tolerance word library).

The embodiments of the present invention may concurrently search in the allographic synonym library while searching for the candidate words from the default word library of the system. When the candidate words found from the default word library of the system are the same as the allographic synonyms found from the allographic synonym library, the candidate words are determined as the allographic synonyms.

Of course, the above method of determining the allographic synonyms merely serves as an example. When the embodiments of the present invention are implemented, other methods of determining the allographic synonyms may be provided according to the actual situation. For example, the found candidate words are matched in the allographic synonym library, and the candidate words are determined as the allographic synonyms in case of successful matching, etc. The embodiments of the present invention are not limited thereto. Furthermore, in addition to the above method of determining the allographic synonyms, a person skilled in the art may also adopt other methods of determining the allographic synonyms according to the actual situation, which are not limited by the embodiments of the present invention.

Step 103: configuring allographic synonym prompt information for the candidate words belonging to the allographic synonyms.

The allographic synonym prompt information may be information for prompting that a certain word is an allographic synonym.

In an alternative embodiment of the present invention, the allographic synonym prompt information may comprise an allographic synonym identifier. In this embodiment of the present invention, Step 103 may comprise the following substep.

Substep S21: configuring the allographic synonym identifier for the candidate words belonging to the allographic synonyms.

In the embodiment of the present invention, the allographic synonym identifier may be a user interface (UI) element which can represent the allographic synonyms, for example, icons, animated cartoons, and characters, etc.

In an alternative embodiment of the present invention, the allographic synonym prompt information may comprise allographic synonym parsing information. In this embodiment of the present invention, Step 103 may comprise the following substep.

Substep S22: configuring a trigger point for the candidate words belonging to the allographic synonyms, wherein the trigger point may be associated with the allographic synonym parsing information.

In the embodiment of the present invention, the allographic synonym parsing information may be information for parsing the allographic synonyms, for example, characters and so on.

In specific implementation, the allographic synonyms may be provided with the associated trigger point. The trigger point may be used for invoking the allographic synonym parsing information of the allographic synonyms.

In an optional example of this embodiment of the present invention, the trigger point may be configured in the allographic synonym identifier.

Step 104: displaying the one or more candidate words and the allographic synonym prompt information.

In the embodiment of the present invention, the candidate words and the allographic synonym prompt information may be displayed to prompt the user the candidate words belonging to the allographic synonyms.

In the embodiment of the present invention, when candidate words searched out using a pinyin character string are allographic synonyms, allographic synonym prompt information is configured for the candidate words, and the candidate words and the allographic synonym prompt information are displayed to prompt a user that the candidate words are the allographic synonyms, thereby reducing a probability of incorrect input and improving input efficiency.

In an alternative embodiment of the present invention, Step 104 may comprise the following substeps.

Substep S31: displaying, in the same interface, at least two candidate words which are allographic synonyms one another.

In the embodiment of the present invention, to facilitate the user to know the allographic synonyms, the allographic synonyms may be displayed in the same interface.

For example, as shown in FIG. 2, candidate words “ [symbol] ” and “ [symbol] ” which are allographic synonyms one another and corresponding to the pinyin character string “san′ yang′ kai′ tai” may be displayed in the interface 200 displaying the candidate words.

In an alternative embodiment of the present invention, Step 104 may comprise the following substeps.

Substep S32: displaying the allographic synonym identifier in an adjacent position of the candidate words belonging to the allographic synonyms.

In the embodiment of the present invention, the adjacent position may refer to a distance between the candidate words and the allographic synonym identifier, which is smaller than a certain distance value, so that the candidate words indicated by the allographic synonym identifier may be identified.

For example, as shown in FIG. 2, the allographic synonym identifier is a dot 201. The dot 201 may be displayed in a top right corner of the candidate words “ [symbol] ” to identify the candidate words “ [symbol] ” as allographic synonyms.

In an alternative embodiment of the present invention, Step 104 may comprise the following substeps.

Substep S33: displaying the allographic synonym parsing information when detecting a designated operation for the candidate words belonging to the allographic synonyms.

In the embodiment of the present invention, the user may trigger the display of the allographic synonym parsing information by the designated operation.

In an alternative embodiment of the present invention, Substep S33 may comprise the following substeps:

Substep S331: generating a popup layer when the trigger point is triggered by the designated operation; and

Substep S332: displaying the allographic synonym parsing information in the popup layer.

In specific implementation, the designated operation may comprise a hover operation.

That is, in the embodiment of the present invention, the trigger point may be triggered by the hover operation according to a mouse at the candidate words (the dot 201 as shown in FIG. 2).

The hover is a method of imitating a hover event (the mouse is moved over an object and the object is moved out), which provides a state of “keeping therein” for a frequently used task. When the mouse is moved over a matched element (such as the trigger point in this embodiment), a designated first function (over (Function), a function to be triggered when the mouse is moved over the element) is triggered. When the mouse moves this element out, a designated second function (out (Function), a function to be triggered when the mouse moves the element out) is triggered. Furthermore, it is detected whether the mouse is still in a special element (for example, in a DIV popup layer). If yes, a “hover” state is continuously maintained, and a move-out event is not triggered. The trigger point specifically may be set up by way of a javascript code.

In the embodiment of the present invention, the popup layer may be a DIV popup layer. Specifically, the popup layer may be created according to the position where the popup layer is, the width of a popup box, the height of the popup box, and the content of the popup layer, etc.

Of course, other designated operations also may be provided in other terminals. For example, in a touch screen terminal, a designated slide gesture operation may be provided, which is not limited by the embodiment of the present invention.

In specific implementation, the allographic synonym parsing information may comprise:

words which are allographic synonyms with the candidate words one another, and/or a link of a parsing page, wherein the parsing page is a page for parsing the words which are allographic synonyms with the candidate words one another.

For example, as shown in FIG. 2, if the trigger point is embedded into the dot 201 of the allographic synonym identifier, the mouse is triggered by the hover operation on the dot 201 to generate the popup layer nearby, so as to display the allographic synonym parsing information 202, comprising words 2021 “the same as [symbol] ” which are the allographic synonyms with the candidate words one another, and a link 2022 “ [symbol] (search in encyclopedia)” of the parsing page.

In an alternative embodiment of the present invention, Step 104 may further comprise the following substep.

Substep S34: invoking a browser to load the parsing page through the link when the link is triggered.

In the embodiment of the present invention, the user may trigger the link by way of clicking and the like, and the input method (an app) may invoke a browser to send the link to the browser. The browser may search, by parsing via a domain name system (DNS), for an Internet Protocol (IP) address mapped by a domain name in the link.

After the IP address is successfully obtained, the browser may request a connection to a server where the IP address is.

After successfully connecting the server where the IP address is, the browser may initiate a request of loading the webpage to the server where the IP address is via a hypertext transfer protocol (HTTP) for request header information.

The server waits for processing after receiving the request and finally returns a response (the parsing page) to the browser.

In one embodiment of the present invention, parsing of the allographic synonym may be captured from a parsing page via the link of the parsing page and displayed in the popup layer.

In the embodiment of the present invention, by displaying allographic synonym parsing information, frequency of operation of starting a browser for search is reduced for the user, operation convenience is improved, time consumption is reduced, and input efficiency is further enhanced.

It should be explained that, for a brief description, method embodiments are describe as a combination of a series of motions. However, those skilled in the art should know that the embodiments of the present invention are not limited by sequences of the motions described. This is because some steps may be performed by using other sequences or be performed simultaneously in accordance with the embodiments of the present invention. In addition, those skilled in the art should also learn that the embodiments described in the specification are preferred embodiments, and involved motions are not necessary for the embodiments of the present invention.

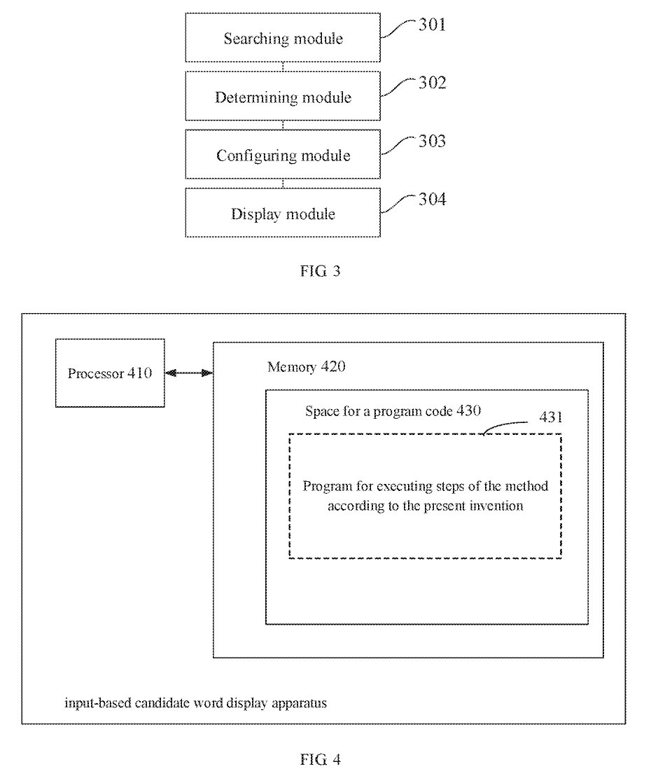

Referring to FIG. 3, a structural block diagram of an input-based candidate word display apparatus according to an embodiment of the present invention is illustrated. Specifically the apparatus may comprise following modules:

a searching module 301, configured to adopt an input pinyin character string to search for one or more candidate words;

a determining module 302, configured to determine whether the candidate words are allographic synonyms; if so, a configuring module 303 is invoked;

the configuring module 303, configured to configure allographic synonym prompt information for the candidate words belonging to the allographic synonyms; and

a display module 304, configured to display the one or more candidate words and the allographic synonym prompt information.

In an alternative embodiment of the present invention, the allographic synonym prompt information may comprise allographic synonym parsing information.

The display module 304 may be further configured to:

display the allographic synonym parsing information when detecting a designated operation for the candidate words belonging to the allographic synonyms.

In an alternative embodiment of the present invention, the configuring module 303 is further configured to:

configure a trigger point for the candidate words belonging to the allographic synonyms, wherein the trigger point is associated with the allographic synonym parsing information.

In an alternative embodiment of the present invention, the display module 304 may be further configured to:

generate a popup layer when the trigger point is triggered by the designated operation; and

display the allographic synonym parsing information in the popup layer.

In an alternative embodiment of the present invention, the allographic synonym prompt information comprises an allographic synonym identifier.

The configuring module 303 may be further configured to:

configure the allographic synonym identifier for the candidate words belonging to the allographic synonyms.

In an alternative embodiment of the present invention, the display module 304 may be further configured to:

display the allographic synonym identifier in an adjacent position of the candidate words belonging to the allographic synonyms.

In specific implementation, the trigger point may be configured in the allographic synonym identifier, and the designated operation may comprise a hover operation.

In an alternative embodiment of the present invention, the display module 304 may be further configured to:

display, in a same interface, at least two candidate words which are allographic synonyms one another.

In specific implementation, the allographic synonym parsing information may comprise:

words which are allographic synonyms with the candidate words one another, and/or a link of a parsing page, wherein the parsing page is a page for parsing the words which are allographic synonyms with the candidate words one another.

In an alternative embodiment of the present invention, the display module 304 may be further configured to:

invoke a browser to load the parsing page through the link when the link is triggered.

In an alternative embodiment of the present invention, the determining module 302 may be further configured to:

adopt the input pinyin character string to search for the allographic synonyms from a preset allographic synonym library.

Device embodiments are basically similar to method embodiments, so description of device embodiments is relatively simple. Please see method embodiments which may serve as reference.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to implement some or all of the functions of some or all of the parts in the input-based candidate word display apparatus according to the embodiment of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

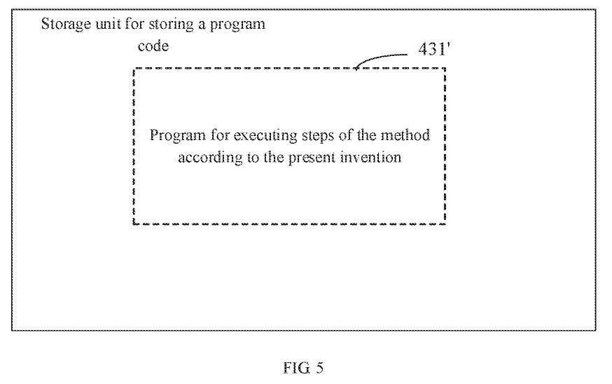

For example, FIG. 4 illustrates an input-based candidate word display apparatus that may implement the input-based candidate word display method according to the present invention. Traditionally, the input-based candidate word display apparatus comprises a processor 410 and a computer program product or a computer readable medium in form of a memory 420. The memory 420 may be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may comprise respective program codes 431 for implementing the respective steps in the method as mentioned above. These program codes may be read from and/or be written into one or more computer program products. These computer program products comprise program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the input-based candidate word display apparatus as shown in FIG. 4. The program codes may be compressed for example in an appropriate form. Usually, the memory cell comprises computer readable codes 431′ which can be read for example by processors 410. When these codes are operated on the input-based candidate word display apparatus, the input-based candidate word display apparatus may execute respective steps in the method as described above.

“One embodiment”, “embodiments” or “one or more embodiments” herein means that particular features, structures or characteristics described in combination with the embodiments are comprised at least one embodiment of the present invention. Furthermore, it is to be noted that the term “in one embodiment” herein does not necessarily refers to the same embodiment.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “comprising/comprise” does not exclude a component or step not listed in the claims. The wording “a” or “an” in front of an element does not exclude the presence of a plurality of such elements. The present invention may be realized by way of hardware comprising a number of different components and by way of a suitably programmed computer. In the unit claim listing a plurality of devices, some of these devices may be embodied in the same hardware. The wordings “first”, “second”, and “third”, etc. do not denote any order. These wordings can be construed as naming.

Also, it should be noticed that the language used in the present specification is chosen for the purpose of readability and teaching, rather than explaining or defining the subject matter of the present invention. Therefore, it is apparent to an ordinary skilled person in the art that modifications and variations could be made without departing from the scope and spirit of the claims as appended. For the scope of the present invention, the publication of the present invention is illustrative rather than restrictive, and the scope of the present invention is defined by the appended claims.

1. An input-based candidate word display method, comprising:
adopting an input pinyin character string to search for one or more candidate words;
determining whether the candidate words are allographic synonyms; if yes, configuring allographic synonym prompt information for the candidate words belonging to the allographic synonyms; and
displaying the one or more candidate words and the allographic synonym prompt information.

2. The method according to claim 1, wherein the allographic synonym prompt information comprises allographic synonym parsing information;
the step of displaying the one or more candidate words and the allographic synonym prompt information comprises:
displaying the allographic synonym parsing information when detecting a designated operation for the candidate words belonging to the allographic synonyms.

3. The method according to claim 2, wherein the step of configuring allographic synonym prompt information for the candidate words belonging to the allographic synonyms comprises:
configuring a trigger point for the candidate words belonging to the allographic synonyms, wherein the trigger point is associated with the allographic synonym parsing information.

4. The method according to claim 3, wherein the step of displaying the allographic synonym parsing information when detecting a designated operation for the candidate words belonging to the allographic synonyms comprises:
generating a popup layer when the trigger point is triggered by the designated operation; and
displaying the allographic synonym parsing information in the popup layer.

5. The method according to claim 1, wherein the allographic synonym prompt information comprises an allographic synonym identifier;
the step of configuring allographic synonym prompt information for the candidate words belonging to the allographic synonyms comprises:
configuring the allographic synonym identifier for the candidate words belonging to the allographic synonyms.

6. The method according to claim 5, wherein the step of displaying the one or more candidate words and the allographic synonym prompt information comprises:
displaying the allographic synonym identifier in an adjacent position of the candidate words belonging to the allographic synonyms.

7. The method according to claim 5, wherein the trigger point is configured in the allographic synonym identifier, and the designated operation comprises a hover operation.

8. (canceled)

9. The method according to claim 2, wherein the allographic synonym parsing information comprises:
words which are allographic synonyms with the candidate words one another, or a link of a parsing page, wherein the parsing page is a page for parsing the words which are allographic synonyms with the candidate words one another.

10. (canceled)

11. The method according to claim 1, wherein the step of determining whether the candidate words are allographic synonyms comprises:
adopting the input pinyin character string to search for the allographic synonyms from a preset allographic synonym library.

12. An input-based candidate word display apparatus, comprising:
a memory having instructions stored thereon;
a processor configured to execute the instructions to perform operations comprising:
adopting an input pinyin character string to search for one or more candidate words;
determining whether the candidate words are allographic synonyms; if yes, a configuring module is invoked;
configuring allographic synonym prompt information for the candidate words belonging to the allographic synonyms; and
displaying the one or more candidate words and the allographic synonym prompt information.

13. The apparatus according to claim 12, wherein the allographic synonym prompt information comprises allographic synonym parsing information; and
the operation of displaying the one or more candidate words and the allographic synonym prompt information comprises:
displaying the allographic synonym parsing information when detecting a designated operation for the candidate words belonging to the allographic synonyms.

14. The apparatus according to claim 13, wherein the operation of configuring allographic synonym prompt information for the candidate words belonging to the allographic synonyms comprises:
configuring a trigger point for the candidate words belonging to the allographic synonyms, wherein the trigger point is associated with the allographic synonym parsing information.

15. The apparatus according to claim 14, wherein the operation of displaying the allographic synonym parsing information when detecting a designated operation for the candidate words belonging to the allographic synonyms comprises:
generating a popup layer when the trigger point is triggered by the designated operation; and
displaying the allographic synonym parsing information in the popup layer.

16. The apparatus according to claim 12, wherein the allographic synonym prompt information comprises an allographic synonym identifier; and
the operation of configuring allographic synonym prompt information for the candidate words belonging to the allographic synonyms comprises:
configuring the allographic synonym identifier for the candidate words belonging to the allographic synonyms.

17. The apparatus according to claim 16, wherein the operation of displaying the one or more candidate words and the allographic synonym prompt information comprises:
displaying the allographic synonym identifier in an adjacent position of the candidate words belonging to the allographic synonyms.

18. The apparatus according to claim 16, wherein the trigger point is configured in the allographic synonym identifier, and the designated operation comprises a hover operation.

19. (canceled)

20. The apparatus according to claim 12, wherein the allographic synonym parsing information comprises:
words which are allographic synonyms with the candidate words one another, or a link of a parsing page, wherein the parsing page is a page for parsing the words which are allographic synonyms with the candidate words one another.

21. (canceled)

22. The apparatus according to claim 12, or 18 or 21, wherein the operation of determining whether the candidate words are allographic synonyms comprises:
adopting the input pinyin character string to search for the allographic synonyms from a preset allographic synonym library.

23. (canceled)

24. A non-transitory computer-readable medium, having computer programs stored thereon that, when executed by one or more processors of a computing device, cause the computing device to perform operations comprising:
adopting an input pinyin character string to search for one or more candidate words;
determining whether the candidate words are allographic synonyms; if yes, configuring allographic synonym prompt information for the candidate words belonging to the allographic synonyms; and
displaying the one or more candidate words and the allographic synonym prompt information.
